(19) United States
(12) Patent Application Publication
(10) Pub. No.: US 2009/0133043 A1
(43) Pub. Date: May 21, 2009

(54) Transfer Device and Recording Medium Driving Device

(76) Inventors: Eiji Hoshinaka, Saitama (JP); Yoshihiro Ichikawa, Saitama (JP); Yosuke Amitani, Saitama (JP)

Correspondence Address: KRATZ, QUINTOS & HANSON, LLP, 1420 K Street, N.W., Suite 400, WASHINGTON, DC, 20005, US

(21) Appl. No.: 12/083,773

(22) PCT Filed: Oct. 18, 2006
(86) PCT No.: PCT/JP2006/320752

§ 371 Date: Nov. 16, 2008

(30) Foreign Application Priority Data
Oct. 19, 2005 (JP) 2005-304454

(51) Int. Cl. G11B 17/04

(52) U.S. Cl. 720/601; G9B/17.013

(57) ABSTRACT

A disc unit includes: a slide stopper adapted to switch a state of the unit between an initial state, a guide-restricted state and a movement-unrestricted state by sliding in right or left direction; and a first plate spring and a second plate spring for biasing the slide stopper in the guide-restricted state or the movement-unrestricted state in a direction to return to an initial position. With this arrangement, the slide stopper can be constantly returned to the initial position unless in the guide-restricted state and the movement-restricted state. Thus, with a simplified arrangement, the disc unit can be switched between the initial state, the guide-restricted state and the movement-unrestricted state.

### TECHNICAL FIELD

The present invention relates to a transfer device for inserting and ejecting a disc recording medium, and a recording-medium driver provided with the transfer device.

### BACKGROUND ART

There have been conventionally known a disc unit capable of guiding a disc recording medium inserted into the unit to a predetermined position by arms, thereby internally holding the disc recording medium (e.g., see Patent Document 1).

The disc unit according to Patent Document 1 includes: a guide body provided within an exterior casing of the unit near a front lateral of the exterior casing; a first slide member and a second slide member slid by a driver in a disc-insertion direction; and a first swinging body and a second swinging body provided on the slide members in a manner rotatable parallel to a disc surface. When a disc is inserted into such a disc unit, the first and second swinging bodies are pressed by an outer periphery of the disc to be outwardly rotated, thereby guiding the disc into the disc unit.

[PATENT DOCUMENT 1] JP-A-2003-16710 (see, page 8, FIGS. 1 to 7)

### DISCLOSURE OF THE INVENTION

### Problems to be Solved by the Invention

In recent years, there has been a demand for a disc unit capable of accepting insertion of discs mutually having different diameters, for instance, a disc unit capable of accepting insertion of both a large-diameter disc having a diameter of 12 cm and a small-diameter disc having a diameter of 8 cm. However, in order to hold discs mutually having different diameters, a disc unit is required to include arrangements operatable corresponding to the discs respectively. Since the first and second swinging bodies of the disc unit according to Patent Document 1 are adapted to transfer discs having the same diameter, the disc unit cannot accept discs mutually having different diameters. Although the disc unit may be additionally provided with swing bodies respectively corresponding to discs mutually having different diameters, such a disc unit tends to have a complicated arrangement and an increased size.

An object of the present invention is to provide a simply-arranged transfer device and a recording-medium driver including the transfer device.

### Means for Solving the Problems

A transfer device according to the present invention includes: a transfer unit including: a guide member that guides a disc recording medium into a driver body, the guide member being adapted to be advanced and retracted relative to a transfer path along which the recording medium is transferred; and a stopper member that switches a guiding state in which the guide member guides the recording medium; and a biasing unit that biases the stopper member so that the guide member becomes a predetermined guiding state.

A recording medium driver according to another aspect of the present invention includes: the above-described transfer device; a processor adapted to perform processing on the recording medium; and the driver body that houses the transfer device and the processor therein and includes an opening from which the recording medium is inserted or ejected.

### BRIEF DESCRIPTION OF DRAWINGS

FIG. 1 is a top view schematically showing the inside of a unit body of a disc unit according to a first embodiment of the present invention.

FIG. 2 is a top view schematically showing the inside of the unit body of the disc unit when an insertion of a large-diameter disc is initiated or when the large-diameter disc has been ejected.

FIG. 3 is a top view showing the inside of the unit body of the disc unit when a large-diameter disc has been transferred.

FIG. 4 is a top view showing the inside of the unit body of the disc unit when a large-diameter disc has been clamped.

FIG. 5 is a top view showing the inside of the unit body of the disc unit when an insertion of a small-diameter disc is initiated or when the small-diameter disc has been ejected.

FIG. 6 is a top view showing the inside of the unit body of the disc unit when a small-diameter disc has been transferred.

FIG. 7 is a top view showing the inside of the unit body of the disc unit when a small-diameter disc has been clamped.

### EXPLANATION OF CODES

1 . . . optical disc serving as a disc
1A . . . large-diameter disc serving as a disc
1B . . . small-diameter disc serving as a disc
10 . . . unit body
24 . . . information processor serving as a processor
30 . . . transfer device
32 . . . link mechanism serving as a transfer unit
100 . . . disc unit
413E . . . first plate spring serving as a biasing unit
413F . . . second plate spring serving as a biasing unit
414 . . . 8 cm arm serving as a guide member
414A . . . arm-restricting pin serving as a pin member
423 . . . link arm serving as a guide member
423C . . . engaging projection serving as a pin member
424 . . . slide stopper serving as a stopper member
424A . . . oblique abutment portion serving as an oblique portion
424G1 . . . cutout serving as an engaging groove
424G2 . . . restricting oblique portion serving as an oblique portion
431 . . . assist arm serving as a guide member

### BEST MODE FOR CARRYING OUT THE INVENTION

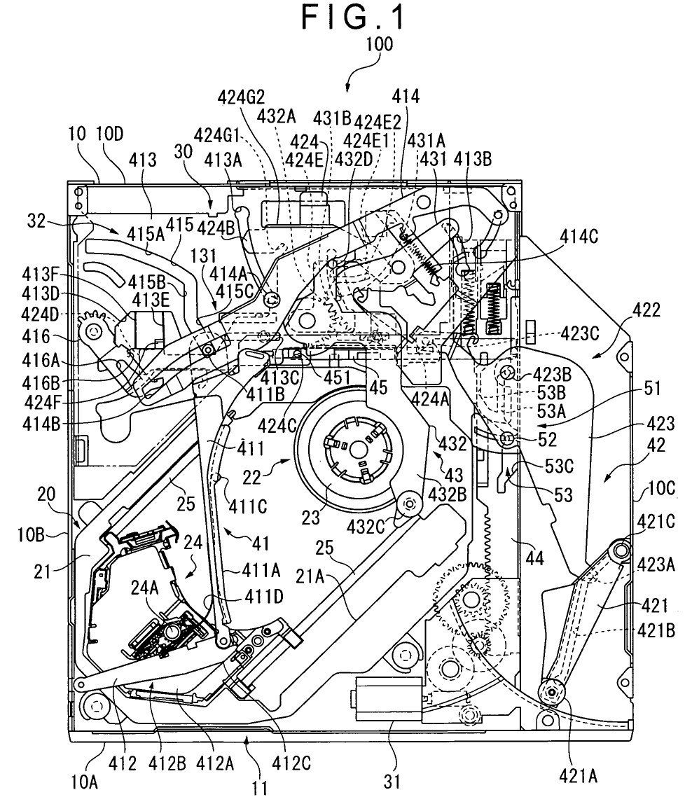

An embodiment of the present invention will be described below with reference to the attached drawings. FIG. 1 is a top view schematically showing an inside of a disc unit according to an embodiment of the present invention.

### [Arrangement of Disc Unit]

In FIG. 1, the numeral 100 denotes a disc unit serving as a recording medium driver according the embodiment of the present invention. The disc unit 100 performs such information processing as reading-processing or recording-processing on an optical disc 1 (a disc) detachably mounted thereon, thereby reading information recorded in a recording surface (not shown) provided on at least one surface of the optical disc 1 or recording a variety of information on the recording surface of the optical disc 1. Although an example of the disc unit 100 is a so-called thinned slot-in type unit that is mounted on an electrical equipment such as a portable personal computer, the disc unit 100 itself may be configured as, for instance, a game machine or a reproducer that performs processing for recording (e.g. video-recording) or reproducing image data. In addition, the disc unit 100 can accept a large-diameter disc 1A having a diameter of 12 cm and a small-diameter disc 1B having a diameter of 8 cm as the optical disc 1. The disc recording medium is not limited to the optical disc 1 but may be other disc recording mediums such as a magnetic disc or a magnetic optical disc. The disc unit 100 includes a substantially box-shaped unit body 10 having an inner space, an exemplary material of which is a metal. In the unit body 10, a lower side of the unit body 10 shown in FIG. 1 may be referred to as a front face 10A, a left lateral wall of the unit body 10 shown in FIG. 1 may be referred to as a left wall 10B, a right lateral wall of the unit body 10 shown in FIG. 1 may be referred to as a right wall 10C and a side opposite to the front face 10A of the unit body 10 shown in FIG. 1 may be referred to as a rear face 10D.

The unit body 10 internally includes a disc processor 20 (a so-called traverse mechanism), a transfer device 30 for transferring the optical disc 1, and a control circuit (not shown). The front face 10A of the unit body 10 is provided with a slot 11 (insertion-and-ejection opening) for inserting/ejecting the optical disc 1, the slot 11 extending in the right-and-left direction of FIG. 1.

The disc processor 20 includes a plate-like mount 21 whose one end is swingably supported by the unit body 10, an exemplary material of which is metal plate. The mount 21 longitudinally extends from the left wall 10B of the unit body 10 near the front face 10A toward the center position of the unit body 10. The mount 21 is longitudinally cut out to substantially centrally form a longitudinal processor opening 21A. A disc rotation driver 22 is disposed near a first end of the processor opening 21A of the mount 21, i.e., substantially at the center of the unit body 10. The disc rotation driver 22 includes a spindle motor (not shown), and a turntable 23 provided integrally with an output shaft of the spindle motor. The spindle motor is controllably connected to the control circuit and driven by electricity supplied from the control circuit. The turntable 23, which is provided substantially at the center inside the unit body 10, is a driver for rotating the optical disc 1.

The mount 21 includes an information processor 24 (processor). The information processor 24, which is supported by a pair of guide shafts 25 while bridging the guide shafts 25, is moved toward and away from the turntable 23 within the processor opening 21A by a moving mechanism (not shown). The information processor 24 has a pickup that includes: a light source (not shown); a pick-up lens 24A for converging light of the light source; and a light sensor (not shown) for detecting specular light reflected from the optical disc 1.

The transfer device 30 includes: a transfer motor 31 disposed in the unit body 10 to be operationally controlled by, for instance, the control circuit; and a link mechanism 32 (a transfer unit) for driving the optical disc 1 when the optical disc is inserted and ejected.

The link mechanism 32 includes: a disc-guide mechanism 41 disposed inside the unit body 10 near the slot 11 and the left wall 10B; a disc-diameter detecting mechanism 42 disposed inside the unit body 10 near the slot 11 and the right wall 10C; a disc-ejecting mechanism 43 for ejecting the optical disc 1 mounted on the turntable 23; and a first driving cam 44 and a second driving cam 45 for swinging the mount 21.

The disc-guide mechanism 41 includes: a guide lever 411 for guiding the transfer of the optical disc 1 when the optical disc 1 is inserted or ejected; a disc guide 412 connected to the guide lever 411 near the front face 10A; a bridge plate 413; and an 8 cm arm 414 (guide member) rotatably provided on the bridge plate 413.

The guide lever 411 is a rod-like member that is longitudinal in a transfer direction of the optical disc 1. A plastic guide portion 411A for guiding the movement of the optical disc 1 in the transfer direction is fixed on an inward lateral of the guide lever 411 (lateral facing the direction in which the optical disc 1 is inserted). The guide portion 411A, which is provided with a guide groove recessed toward the left wall 10B, guides the optical disc 1 by slidably contacting the periphery of the optical disc 1 with the guide groove. The guide portion 411A is provided with a rotation-restricting pin 411C that downwardly protrudes. The lateral of the guide lever 411 is inwardly bent where the lateral is continued from the guide portion 411A near the rear face 10D, thereby restricting the movement of the optical disc 1.

A guide pin 411B that penetrates from the top to the bottom is fixed on an end of the guide lever 411 adjacent to the rear face 10D. The guide pin 411B is locked by the later-described bridge plate 411 and the 8 cm arm 413. The disc guide 412 is rotatably connected to an end of the guide lever 411 adjacent to the front face 10A.

The end of the guide lever 411 adjacent to the front face 10A is further provided with a plate spring 411D that faces the left wall 10B. The plate spring 411D inwardly biases a connecting portion of the guide lever 411 and the disc guide 412 when the guide lever 411 is moved toward the left wall 10B. With this arrangement, the connecting portion of the guide lever 411 and the disc guide 412 is prevented from bending outwardly.

The disc guide 412 is longitudinally formed, whose first end is rotatably mounted in the vicinity of the left wall 10B of the unit body 10. In addition, as described above, a second end of the disc guide 412 is rotatably connected to the end of the guide lever 411. With this arrangement, the end of the guide lever 411 adjacent to the front face 10A can be rotationally moved along a circular arc described around the first end of the disc guide 412 with radius of a length of the disc guide 412. An inwardly-protruding flange 412A is formed below the disc guide 412. A slide-contact surface 412B, with which the optical disc 1 is slidably in contact at its periphery when being inserted, is formed along the flange 412A. The connecting portion of the disc guide 412 and the guide lever 411 serves as a pressing portion 412C for pressing the periphery of the optical disc 1 toward the front face 10A when the optical disc 1 is ejected.

The bridge plate 413 extends both in the right and left directions near the rear face 10D of the unit body 10. The bridge plate 413 covers the above-described control circuit from the above so as to protect the control circuit. Near the left wall 10B, the bridge plate 413 is provided with a leading guide groove 415 that extends from a rear corner of the unit body 10 toward the inner central position.

The leading guide groove 415 includes: an arc groove 415A formed to be substantially parallel to the rotation locus described by the connecting portion of the guide lever 411 and the disc guide 412; a linear groove 415B continued from the arc groove 415A to extend substantially along the transfer direction of the optical disc 1; and an oblique groove 415C continued from the linear groove 415B to be oblique to the linear groove 415B by a predetermined angle toward the center position of the unit body 10. The leading guide groove 415 is engaged with the guide pin 411B that downwardly protrudes from the guide lever 411, thereby guiding the movement of the guide lever 411. The linear groove 415B is arranged such that a perpendicular line drawn from the center of the turntable 23 to the extension of the linear groove 415B substantially equals to the radius of the small-diameter disc 1B.

The bridge plate 413 rotatably supports the 8 cm arm 414 near the right wall 10C. The bridge plate 413 is provided with arm-restricting grooves 413A centrally and near the right wall 10C. The arm-restricting grooves 413A are arced around the support position of the 8 cm arm 414 to restrict a rotation region of the 8 cm arm 414.

The bridge plate 413 also rotatably supports an assist arm 431 of the later-described disc ejecting mechanism 43 near the right wall 10C. An assist-restricting groove 413B is arced around the rotation center of the assist arm 431. Substantially at the center of the bridge plate 413, an ejection arm 432 meshed with the assist arm 431 is rotatably supported. The bridge plate 413 is provided with a control groove 413C near the front face 10A, which longitudinally extends in the right-and-left direction.

The bridge plate 413 is opened near the left wall 10B to provide a spring-controlling window 413D. A rear portion of the spring-controlling window 413D is provided with a first plate spring 413E and a second plate spring 413F in a fixed manner, both of which extend toward the front face 10A. The first plate spring 413E is provided on the spring-controlling window 413D adjacent to the right wall 10C while the second plate spring 413F is provided on the spring-controlling window 413D to be spaced apart from the first plate spring 413E by a predetermined distance. The first plate spring 413E and the second plate spring 413F are positioned so as not to bias a later-described slide stopper 424 (stopper member) in either of the right and left directions when no optical disc 1 is inserted in the disc unit 100 (i.e., in an initial state). The distance by which the second plate spring 413F is spaced apart from the first plate spring 413 is set to be smaller than a distance by which the slide stopper 424 is moved in the right-and-left directions.

The bridge plate 413 rotatably supports a push arm 416 at a position more adjacent to the left wall 10B than the spring-controlling window 413D. The push arm 416, which is longitudinally formed, is provided with a pin-locking groove 416A that extends from a first longitudinal end of the push arm 416 to the supporting position of the push arm 416. The pin-locking groove 416A accepts insertion of the rotation-restricting pin 411C provided on the guide portion 411A when the guide pin 411B of the guide lever 411 moves within the arc groove 415A of the leading guide groove 415. When the guide lever 411 is further moved toward the left wall 10B and the rotation-restricting pin 411C pushes the pin-locking groove 416A, the push arm 416 is rotated toward the left wall 10B. A right portion of the push arm 416 is provided with a press piece 416B that downwardly protrudes to be inserted in the spring-controlling window 413D. The press piece 416B is rotationally movable within the spring-controlling window 413D in accordance with the rotary movement of the push arm 416 while being abuttable on a push stopper 424D of the later-described slide stopper 424 when the push arm 416 is rotated to be the closest to the left wall 10B. The abutment of the press piece 416B on the push stopper 424D restricts the rotary movement of the press piece 416B so as to also restrict the rotation of the push arm 416, such that the guide lever 411 is kept close to the left wall 10B (kept in a guide-restricted state).

As described above, the 8 cm arm 414 is rotatably supported by the bridge plate 413 near the right wall 10C. The 8 cm arm 414 includes an arm-restricting pin 414A that downwardly protrudes. The arm restricting pin 414A is engaged with the arm-restricting groove 413A of the bridge plate 413. The distal end of the 8 cm arm 414 is provided with a guide-link groove 414B that extends along the longitudinal direction of the 8 cm arm 414. The guide link groove 414B is engaged with the guide pin 411B that upwardly protrudes from the guide lever 411. In the vicinity of the support position of the 8 cm arm 414, an arm-biasing spring 414C for biasing the distal end (i.e., end adjacent to the left wall 10B) of the 8 cm arm 414 toward the front face 10A is provided. The arm-biasing spring 414C constantly biases the 8 cm arm 414 counterclockwise. The 8 cm arm 414 biases the guide lever 411 such that the guide pin 411B returns to an initial state to be positioned at a distal position of the oblique groove 415C of the leading guide groove 415.

The disc-diameter detecting mechanism 42 removes movement restriction of the guide lever 411 of the disc-guide mechanism 41 when the optical disc 1 inserted in the slot 11 is a large-diameter disc 1A while restricting the movement of the guide lever 411 when the inserted optical disc 1 is a small-diameter disc 1B.

Specifically, the disc-diameter detecting mechanism 42 includes: a load arm 421 whose first end abuts on the optical disc 1 and whose second end is rotatable relative to the unit body 10; and an arm-link mechanism 422 connected to the load arm 421 for removing the movement restriction of the guide lever 411 when the rotation angle of the load arm 421 is large while restricting the movement of the guide lever 411 when the rotation angle of the load arm 421 is small.

The first end of the load arm 421 is provided with a roller-type abutment portion 421A for abutting on the periphery of the optical disc 1 while the second end of the load arm 421 is rotatably supported by the unit body 10. The load arm 421, which is made of an elongated rectangular plate member, includes a guide groove 421B that extends along the longitudinal direction of the load arm 421. The load arm 421 is biased by a biasing unit (not shown) clockwise so as to return to the initial position as shown in FIG. 1.

The arm-link mechanism 422 includes: a substantially-tabular link arm 423 (guide member) whose first end is provided with a projection 423A guided by the guide groove 421B; and the substantially-tabular slide stopper 424 (stopper member) whose first end is coupled to the link arm 423.

The load arm 421 and the link arm 423 are located adjacent to the right wall 10C within the unit body 10 and disposed on substantially the same plane as the guide lever 411 and the disc guide 412 of the disc-guide mechanism 41.

A second end of the link arm 423, which is supported in a manner rotatable around a rotary shaft 423B fixed on the unit body 10, is provided with an engaging projection 423C (pin member) positioned to be opposite to the projection 423A relative to the rotary shaft 423B. In addition, the second end of the link arm 423 (the end where the engaging projection 423C is provided) is further provided with a biasing unit (not shown) for biasing the link arm 423 toward the right wall 10C. With this arrangement, the load arm 421 is inwardly biased, i.e., biased clockwise.

The slide stopper 424, which is disposed below the bridge plate 413 to be closer to the rear face 10D than the turntable 23, is movable both in the right and left directions in the drawing(s). A right end of the slide stopper 423 is provided with an oblique abutment portion 424A that is oblique to the transfer direction of the optical disc 1 for abutting on the engaging projection 423C. When a large-diameter disc 1A is inserted as the optical disc 1 and the load arm 421 is rotated, the link arm 423 is also rotated, such that the engaging projection 423C is moved toward the front face 10A to press the oblique abutment portion 424A abutting the engaging projection 423C, thereby sliding the slide stopper 424 toward the right wall 10C. In addition, the slide stopper 424 is provided with a restricting stopper 424B adapted to partially block the arm-restricting groove 413A of the bridge plate 413. When the slide stopper 424 is moved toward the right wall 10C by the rotation of the load arm 421 as described above, the restricting stopper 424B clears the arm restricting groove 413A, so that the arm-restricting pin 414A of the 8 cm arm 414 can be moved within the groove 413A (a movement-unrestricted state). On the other hand, when the load arm 421 returns to the initial position and the slide stopper 424 returns to the initial position, the restricting stopper 424B blocks the arm restricting groove 413A, thereby preventing the movement of the arm-restricting pin 414A. With this arrangement, the rotation of the guide lever 411 coupled to the 8 cm arm 414 is also restricted, and the guide lever 411 becomes movable toward the left wall 10B.

Adjacently to the front face 10A, the slide stopper 424 is provided with a cam-interlocking groove 424C into which a cam pin 451 of the second driving cam 45 is inserted. The cam-interlocking groove 424C, which is longitudinal in the right-and-left direction, is engaged with the cam pin 451 with the cam pin 451 being inserted into a portion of the groove 424C. In other words, a play of a predetermined size is provided between the cam-interlocking groove 424C and the cam pin 451. With this arrangement, when the second driving cam 45 is moved toward the left wall 10B, the slide stopper 424 remains unmoved until the cam pin 451 abuts on a left end of the cam-interlocking groove 424C. With the cam pin 451 abutting on the left end of the cam-interlocking groove 424C to press the left end toward the left wall 10B, the slide stopper 424 is moved toward the left wall 10B.

Adjacently to the left wall 10B, the slide stopper 424 is provided with the push stopper 424D. When the slide stopper 424 is moved toward the left wall 10B by the movement of the second driving cam 45, the push stopper 424D abuts on the press piece 416B of the push arm 416 to restrict the rotation of the push arm 416.

Substantially the center of the slide stopper 424 is opened to provide an ejection-restricting window 424E. The ejection-restricting window 424E includes an ejection-restricting groove 424E1 for the large-diameter disc and an ejection-restricting groove 424E2 for the small-diameter disc that extend in the right-and-left direction. When the slide stopper 424 is moved toward the left wall 10B by the movement of the second driving cam 45, the ejection-restricting grooves 424E1, 424E2 are engaged with an ejection-restricting pin 431A of the later-described assist arm 431, thereby restricting the rotation of the assist arm 431. The ejection-restricting grooves 424E1, 424E2 each have a distal end that is sloped in a direction to be away from the turntable 23. By engaging the sloped portions of the distal ends with the ejection-restricting pin 431A, a clearance can be secured between the ejection arm 431 and the optical disc 1.

A right portion of the restricting stopper 424B is provided with a recessed cutout 424G1 (locking groove) that is recessed toward the right rear side. The cutout 424G1 is locked with the arm-restricting pin 414A when a small-diameter disc 1B is clamped on the turntable 23, thereby restricting the movement of the 8 cm arm 414. Specifically, when the slide stopper 424 is moved toward the left wall 10B with a small-diameter disc 1B being clamped, the cutout 424G1 is also moved toward the left wall 10B, thereby being engaged with the arm-restricting pin 414A of the 8 cm arm 414. When the slide stopper 424 is subsequently further moved toward the left wall 10B, the arm-restricting pin 414A is moved toward the rear face 10D along the cutout 424G1. The guide pin 411B of the guide lever 411 connected to the 8 cm arm 414 is accordingly also moved toward the rear face 10D along the arc groove 415A of the leading guide groove 415. With this operation, the guide lever 411 is moved toward the left wall 10B along the arc groove 415A so as to be positioned while a clearance of a predetermined size is maintained between the guide lever 411 and the small-diameter disc 1B (guide-restricted state).

A rear portion of the restricting stopper 424B of the slide stopper 424 is provided with a restricting oblique portion 424G2 (oblique portion) that is oblique to the transfer direction of the optical disc 1. The restricting oblique portion 424G2 is engaged with the arm-restricting pin 414A when a large-diameter disc 1A is clamped on the turntable 23, thereby restricting the movement of the 8 cm arm 414. Specifically, when the slide stopper 424 is moved toward the left wall 10B with a large-diameter disc 1A being clamped, the restricting oblique portion 424G2 is also moved toward the left wall 10B to be engaged with the arm-restricting pin 414A of the 8 cm arm 414, such that the arm-restricting pin 414A is moved toward the rear face 10D along the oblique of the restricting oblique portion 424G2. With this operation, the guide lever 411 connected to the 8 cm arm 414 is also moved toward the left wall 10B along the arc groove 415A so as to be positioned where a clearance of a predetermined size is maintained between the 8 cm arm 414 and the large-diameter disc 1A (guide-restricted state).

A left portion of the slide stopper 424 is provided with a spring-locking projection 424F in the vicinity of the push stopper 424D. The spring-locking projection 424F is sandwiched by the first plate spring 413E and the second 413F within the spring-controlling window 413D of the bridge plate 413. The spring-locking projection 424F abuts on the first plate spring 413E without being biased by the first plate spring 413E in the initial state. When the movement-unrestricted state is initiated with the slide stopper 424 being moved toward the right wall 10C by the rotation of the load arm 421, the spring-locking projection 424F bows the first plate spring 413E toward the right wall 10C, such that the spring-locking projection 424F is biased by the first plate spring 413E in a direction to return to the initial state, i.e., toward the left wall 10B. When the load arm 421 is returned to the initial position, the engaging projection 423C is moved away from the oblique abutment portion 424A, such that the first plate spring 413E biases the spring-locking projection 424F toward the left wall 10B. With this arrangement, the slide stopper 424 is moved toward the left wall 10B again, thereby returning to the initial state.

When a guide-restricted state is initiated with the slide stopper 424 being moved toward the left wall 10B in conjunction with the movement of the second driving cam 45 toward the left wall 10B, the spring-locking projection 424F presses and bows the second plate spring 413F toward the left wall 10B, such that the spring-locking projection 424F is biased by the second plate spring 413F in a direction to return to the initial state, i.e., toward the right wall 10C. On the other hand, when the second driving cam 45 is moved toward the right wall 10C, the slide stopper 424 is biased by the second plate spring toward the right wall 10C to be moved toward the right wall 10C.

The disc ejecting mechanism 43 presses the optical disc 1 toward the slot 11 for ejection. The disc ejecting mechanism 43 includes the assist arm 431 (guide member) and an ejection arm 432.

As described above, the assist arm 431, which is rotatably provided on the bride plate 413 near the right wall 10C, includes the ejection-restricting pin 431A to be engageable with an assist-restricting groove 413B. With this arrangement, the rotation region of the assist arm 431 is restricted to be within the assist-restricting groove 413B. As also described above, the ejection-restricting pin 431A, which is inserted in the ejection-restricting window 424E, is engaged with the ejection-restricting groove 424E1 for the large-diameter disc or the ejection-restricting groove 424E2 for the small-diameter disc by the movement of the slide stopper 424, thereby restricting the rotation of the assist arm 431. An end of the assist arm 431 adjacent to the left wall 10B is provided with a gear 431B. The assist arm 431 is biased by a biasing member (not shown) counterclockwise, i.e., biased in a direction in which the gear 431B is turned toward the front face 10A.

The ejection arm 432, which is rotatably provided on the bridge plate 413 as described above, includes: a gear portion 432A located below the bridge plate 413 while sandwiching the bridge plate 413 against the ejection arm 432; and a longitudinal arm 432B located above the bridge plate 413. The gear portion 432A is meshed with the gear 431B of the assist arm 431 and biased clockwise by biasing force of the assist arm 431. The biasing force biases the arm 432B clockwise, i.e., a direction to press the optical disc 1 to the slot 11. A distal end of the arm 432B is provided with a roller-type abutment portion 432C for abutting on the periphery of the optical disc 1. Further, an arm-controlling projection 432D is provided at a position opposite to the arm 432B relative to the rotary center of the ejection arm 432. The arm-controlling projection 432D abuts on the periphery of the 8 cm arm 414 when the ejection arm 432 is rotated.

The first driving cam 44 and the second driving cam 45 are respectively provided with engaging grooves (not shown) with which locking cam projections (not shown) formed on two laterals of the mount 21 are engaged. The first driving cam 44 and the second driving cam 45, which are elongated members, are advanced and retracted by a motor and a gear mechanism (not shown) along the longitudinal direction. With this arrangement, the mount 21 is swung so as to be closer to or away from the recording surface of the optical disc 1 mounted on the turntable 23.

The link arm 423 and the first driving cam 44 each include a disc-transferring cam 51 for decreasing a transfer amount of the optical disc 1 to be transferred to the turntable 23 when the optical disc 1 is the large-diameter disc 1A and for increasing the transfer amount of the optical disc 1 to be transferred to the turntable 23 when the optical disc 1 is the small-diameter disc 1B.

The disc-transferring cam 51 includes a projection 52 provided on the link arm 423, and a cam groove 53 provided on the first driving cam 44 to be engageable with the projection 52.

The cam groove 53 includes: a first cam groove 53A for transferring the large-diameter disc 1A; a second cam groove 53B for transferring the small-diameter disc 1B; and a common cam groove 53C whose one end is linked with the first cam groove 53A and the second cam groove 53B. The first cam groove 53A and the second cam grove 53B extend in a direction in which the first driving cam 44 is moved.

The second driving cam 45, which is coupled to the first driving cam 44, advances and retracts in the right-and-left direction in interlock with the advancement and retraction of the first driving cam 44. When a sensor (not shown) detects that the center of the optical disc 1 is located above the turntable 23, the first driving cam 44 is moved toward the rear face 10D and the second driving cam 45 is moved toward the left wall 10B. As described above, the second driving cam 45 includes the cam pin 451 that upwardly protrudes, and the cam pin 451 is engageable with the cam-interlocking groove 424C of the slide stopper 424. The movement of the second driving cam 45 moves the mount 21 closer to the recording surface of the optical disc 1, such that the optical disc 1 is clamped on the turntable 23. The turntable 23 is rotated in this state, such that information is recorded and/or reproduced in or from the optical disc 1.

### [Operation of Disc Unit]

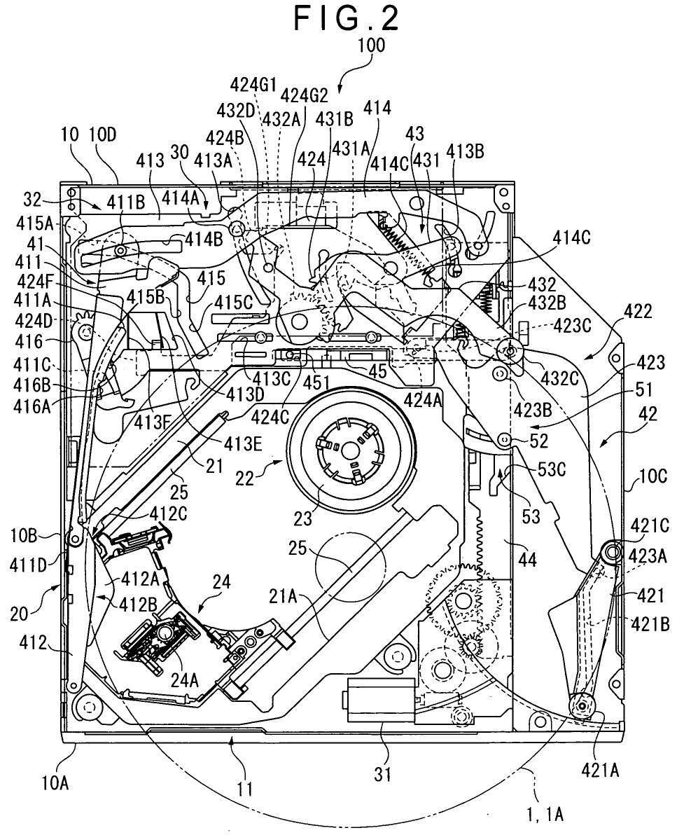

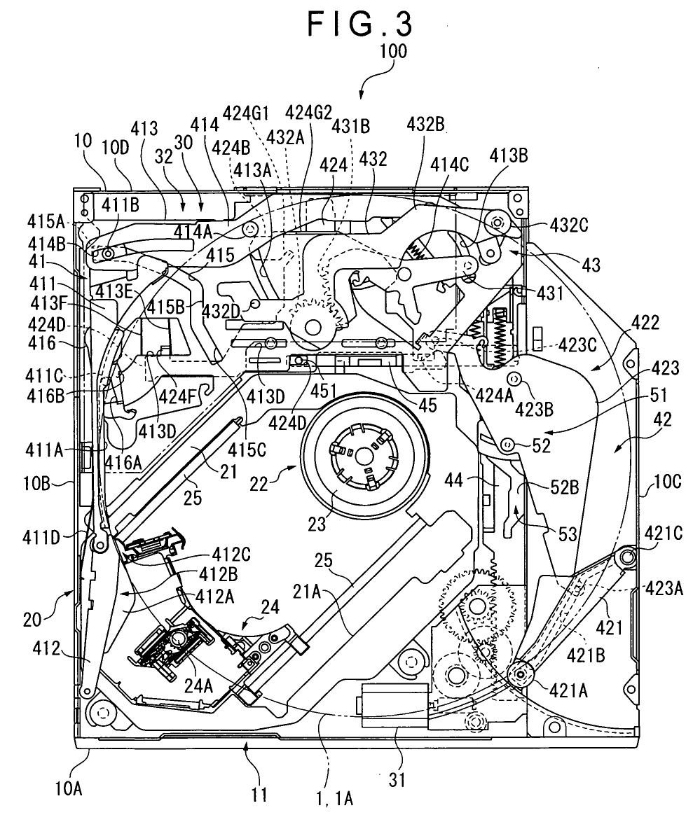

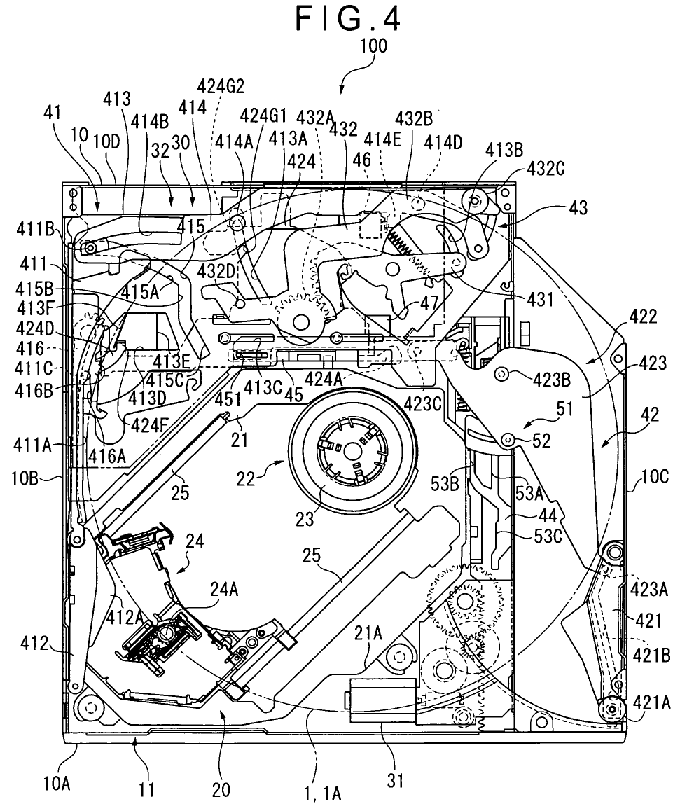

Next, operation(s) of the disc unit 100 will be described by reference to FIGS. 2 to 7. FIG. 2 is a top view showing the inside of the unit body of the disk unit when the insertion of the large-diameter disc 1A is initiated or when the large-diameter disc has been ejected. FIG. 3 is a top view showing the inside of the unit body of the disc unit when a large-diameter disc has been inserted. FIG. 4 is a top view showing the inside of the unit body of the disc unit when a large-diameter disc has been clamped.

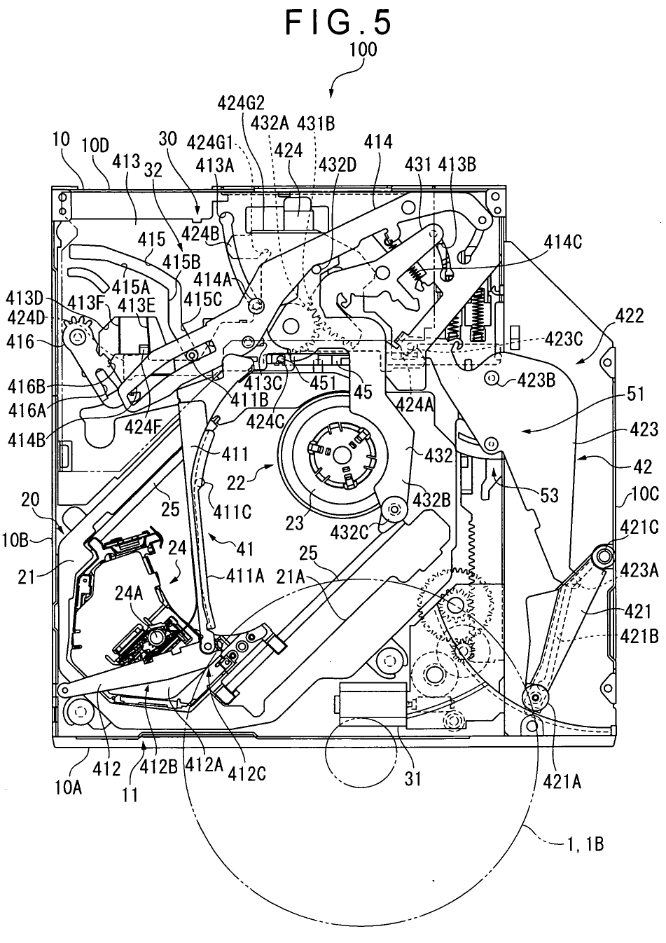

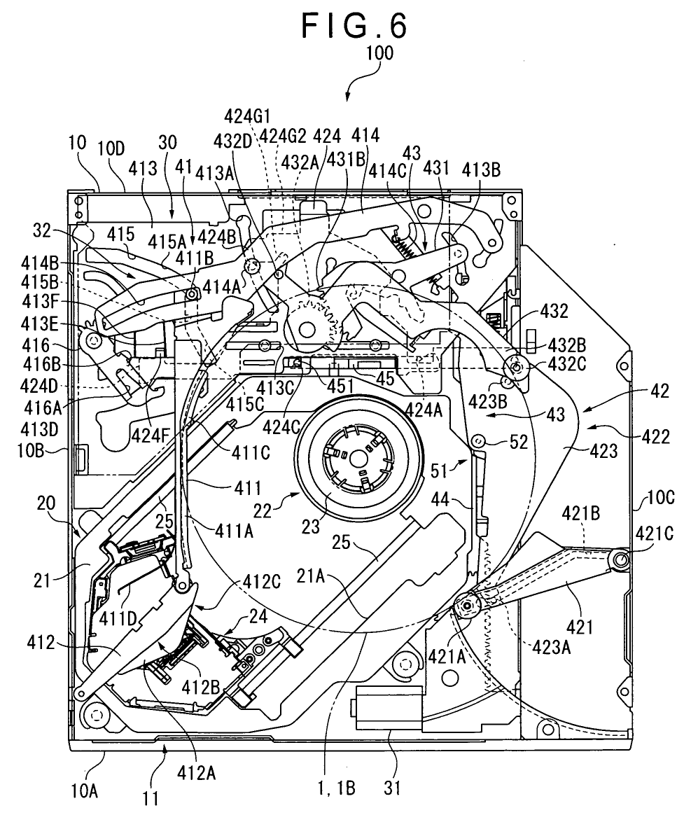

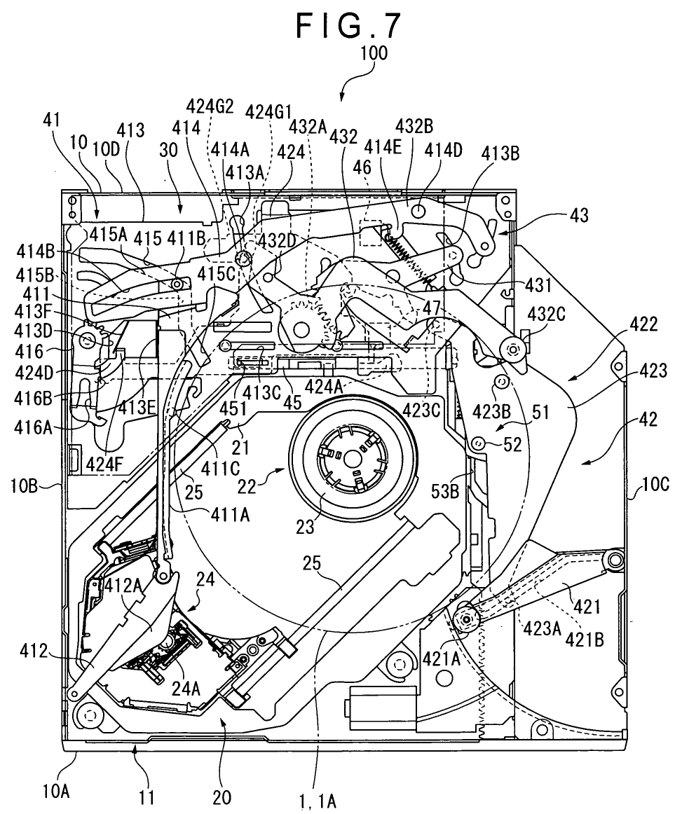

FIG. 5 is a top view schematically showing the inside of the unit body of the disk unit when the insertion of a small-diameter disc 1A is initiated or when the small-diameter disc has been ejected. FIG. 6 is a top view showing the inside of the unit body of the disk unit when a disc (small-diameter disc) has been inserted. FIG. 7 is a top view showing the inside of the unit body of the disk unit when a disc (small-diameter disc) has been inserted.

### (Insertion of Large-Diameter Disc)

Operation(s) of the disc unit when the large-diameter disc 1A having a disc diameter of 12 cm is inserted in the disc unit 100 in the initial state as shown in FIG. 1 will be explained below. When the large-diameter disc 1A is inserted in the slot 11 of the disc unit 100 in the initial state, the periphery of the large-diameter disc 1A presses the abutment portion 421A of the load arm 421 toward the right wall 10C as shown in FIG. 2, thereby rotating the load arm 421. Then, the link arm 423 is rotated counterclockwise, such that the engaging projection 423C is moved toward the front face 10A to press the oblique abutment portion 424A, thereby sliding the slide stopper 424 toward the right wall 10C. The movement of the slide stopper 424 disengages the restricting stopper 424B from the arm-restricting groove 413A of the bridge plate 413, thereby removing restriction of the rotation region of the 8 cm arm 414 (i.e., the movement-unrestricted state is initiated). Since the slide stopper 424 is moved toward the right wall 10C, the spring-locking projection 424F presses and bows the first plate spring 413E provided on the spring-controlling window 413D of the bridge plate 413 toward the right wall 10C.

When the large-diameter disc 1A is further inserted in the unit in this state, the periphery of the large-diameter disc 1A laterally abuts on the slide-contact surface 412B of the disc guide 412, thereby rotating the disc guide 412 toward the left wall 10B. At this time, the guide lever 411 is also pressed toward the rear face 10D, thereby moving the guide pin 411B from the oblique groove 415C and the linear groove 415B of the leading guide groove 415 to the arc groove 415A. Then, with the guide pin 411B moving toward the left wall 10B along the arc groove 415A, the guide lever 411 is moved toward the left wall 10B while remaining substantially parallel to the disc inserting/ejecting direction, so that the guide portion 411A guides the periphery of the large-diameter disc 1A. In addition, the rotation-restricting pin 411C of the guide portion 411A is engaged with the pin-locking groove 416A of the push arm 416 at this time, such that the push arm 416 is also rotated toward the left wall 10B.

When the right periphery of the large-diameter disc 1A passes the abutment portion 421A of the load arm 421, the load arm 421 is biased by the biasing unit provided on the link arm 423 to be returned to the initial position. With this operation, the load arm 421 is rotated inward, such that the engaging projection 423C is moved toward the rear face 10D. When the movement restriction is removed with the engaging projection 423C being moved away from the oblique abutment portion 424A, the spring-locking projection 424F is biased by the first plate spring 413E toward the left wall 10B, such that the slide stopper 424 is moved to the position in the initial state again.

When the center of the large-diameter disc 1A is subsequently further moved to the position above the turntable 23 (i.e., the disc has been transferred) as shown in FIG. 3, the clamping of the large-diameter disc 1A on the turntable 23 is initiated. Specifically, the insertion of the large-diameter disc 1A presses an insertion-detecting switch (not shown), such that the first driving cam 44 moved toward the front face 10A. At this time, the projection 52 is inserted into the first cam groove 53A of the first driving cam 44, thereby fixing the position of the load arm 421 while a clearance is maintained between the load arm 421 and the large-diameter disc 1A. The second driving cam 45 is also moved toward the left wall 10B in interlock with the movement of the first driving cam 44. Then, the mount 21 is upwardly moved in interlock with the first and second driving cams 44, 45, thereby clamping the large-diameter disc 1A on the turntable 23 as shown in FIG. 4.

The cam pin 451 is also moved toward the left wall 10B along the cam-interlocking groove 424C by the movement of the second driving cam 45. When abutting on the left end of the cam-interlocking groove 424C, the cam pin 451 presses the left end of the cam-interlocking groove 424C toward the left wall 10B. With this operation, the slide stopper 424 is moved toward the left wall 10B. By the movement of the slide stopper 424 toward the left wall 10B by a predetermined distance, the spring-locking projection 424F presses and bows the second plate spring 413F toward the left wall 10B.

In addition, by the movement of the slide stopper 424 toward the left wall 10B, the arm-restricting pin 414A of the 8 cm arm 414 is engaged with the restricting oblique portion 424G2. Specifically, when the arm-restricting pin 414A is moved toward the rear face along the oblique of the restricting oblique portion 424G2, the guide lever 411 is moved toward the left wall 10B, such that the movement of the guide lever 411 is restricted while a clearance of a predetermined size is maintained between the guide lever 411 and the large-diameter disc 1A (the guide-restricted state). Further, the push stopper 424D of the slide stopper 424 presses the press piece 416B of the push arm 416 toward the left wall 10B to more reliably move the guide lever 411 toward the left wall 10B, thereby restricting the movement of the guide lever 411 (the guide-restricted state).

In addition, the ejection-restricting pin 431A of the assist arm 431 is engaged with the ejection-restricting groove 424E1 for the large-diameter disc by the movement of the slide stopper 424, thereby restricting the movement of the abutment portion 432C of the ejection arm 432 while a clearance of a predetermined size is maintained between the abutment portion 432C and the large-diameter disc 1A (the guide-restricted state).

When operation signal for processing the information of the large-diameter disc 1A is exemplarily input by a user, the information processor 24 irradiates light of a predetermined wavelength onto the recording surface of the large-diameter disc 1A and performs information processing.

### (Ejection of Large-Diameter Disc)

Next, operation(s) of ejecting the large-diameter disc 1A will be described. When, for example, a user presses an ejection button, the first driving cam 44 is initially moved toward the rear face 10D, such that the second driving cam 45 is also moved toward the right wall 10C in interlock with the first driving cam 44. Since the cam pin 451 is also moved toward the right wall 10C, the force pressing the slide stopper 424 toward the left wall 10B is lost. Accordingly, the spring-locking projection 424F is biased by the second plate spring 413F toward the right wall 10C, thereby moving the slide stopper 424 toward the right wall 10C. After the second plate spring 413F is returned to the initial position, i.e., the position where the second plate spring 413F becomes parallel to the transfer direction of the large-diameter disc 1A, the cam pin 451 of the second driving cam 45 abuts on the right end of the cam-interlocking groove 424C to press the right end toward the right wall 10C, thereby returning the slide stopper 424 to the initial position as shown in FIG. 3. By the above-described movement of the slide stopper 424 toward the right wall 10C, the push stopper 424D, the restricting oblique portion 424G2 and the ejection-restricting window 424E are also moved toward the right wall 10C. By the movement of the second driving cam 45 toward the right wall 10C, the turntable 23 is also moved downward to stop clamping the large-diameter disc 1A with the movement of the second driving cam 45 toward the right wall 10C, and the guide lever 411 and the ejection arm 432, whose movement restriction has been removed at the same time, holds the large-diameter disc 1A. Then, when the first driving cam 44 is moved toward the rear face 10D, the movement restriction of the load arm 421 is also removed.

Subsequently, the biasing force of the ejection arm 432 presses the large-diameter disc 1A toward the front face 10A. When the left periphery of the large-diameter 1A passes the connecting portion of the guide lever 411 and the disc guide 412 to be further ejected toward the front face 10A, the pressing portion 412C of the disc guide 412 presses the periphery of the large-diameter disc 1A toward the front face 10A, thereby ejecting the large-diameter disc 1A.

### (Insertion of Small-Diameter Disc)

Next, operation(s) of the disc unit when the small-diameter disc 1B having a disc diameter of 8 cm is inserted in the disc unit 100 in the initial state as shown in FIG. 1 will be explained below. When the small-diameter disc 1B is inserted through the slot 11 of the disc unit 100, the periphery of the small-diameter disc 1B presses the disc guide 412 to rotate the rotate the disc guide 412 toward the left wall 10B. At this time, the guide lever 411 is also pressed toward the rear face 10D, thereby moving the guide pin 411B from the oblique groove 415C of the leading guide groove 411 to the linear groove 415B. Since the load arm 421 is not rotated when the small-diameter disc 1B is inserted through the slot 11 substantially at the center thereof, the slide stopper 242 is not slid at the initial stage of the insertion of the small-diameter disc 1B.

Then, the small-diameter disc 1B is transferred to the position above the turntable 23 by the guide lever 411, the load arm 421 and the ejection arm 432 as shown in FIG. 6. When the center of the small-diameter disc 1B is transferred to the position above the turntable 23 (the transfer of the disc has been completed), the small-diameter disc 1B is clamped on the turntable 23. Specifically, as in clamping the large-diameter disc 1A, with the insertion of the small-diameter disc 1B pressing the insertion-detecting switch (not shown), the first driving cam 44 and the second driving cam 45 are moved to upwardly move the mount 21, thereby clamping the small-diameter disc 1B on the turntable 23.

At this time, as in clamping the large-diameter disc 1A, with the second driving cam 45 being moved toward the left wall 10B, the cam pin 451 abuts on the left end of the cam-interlocking groove 424C of the slide stopper 424, such that the slide stopper 424 is moved toward the left wall 10B (i.e., in the same direction as the second driving cam 45). By the movement of the slide stopper 424 toward the left wall 10B by a predetermined distance, the spring-locking projection 424F presses and bows the second plate spring 413F toward the left wall 10B. In addition, the arm-restricting pin 414A of the 8 cm arm 414 is engaged with the cutout 424G1 of the slide stopper 424, thereby restricting the movement of the guide lever 411 linked with the 8 cm arm 414 while a clearance of a predetermined size is maintained between the guide lever 411 and the small-diameter disc 1B (the guide-restricted state).

The ejection-restricting pin 431A of the assist arm 431 is engaged with the ejection-restricting groove 424E2 for the small-diameter disc by the movement of the slide stopper 424, thereby restricting the movement of the abutment portion 432C of the ejection arm 432 while a clearance of a predetermined size is maintained between the abutment portion 432C and the small-diameter disc 1B (the guide-restricted state).

When operation signal for processing the information of the small-diameter disc 1B is exemplarily input by a user, the information processor 24 irradiates light of a predetermined wavelength onto the recording surface of the small-diameter disc 1B and performs information processing.

### (Ejection of Small-Diameter Disc)

Next, operation(s) of ejecting the small-diameter disc 1B will be described. When, for example, a user presses an ejection button, as in the ejection of the large-diameter disc 1A, the first driving cam 44 is initially moved toward the rear face 10D, such that the second driving cam 45 is also moved toward the right wall 10C in interlock with the first driving cam 44. Since the cam pin 451 is also moved toward the right wall 10C, the force pressing the slide stopper 424 toward the left wall 10B is lost. The slide stopper 424 is accordingly moved toward the right wall 10C by the biasing force of the second plate spring 413F. After the second plate spring 413F is returned to the initial position, the cam pin 451 of the second driving cam 45 abuts on the right end of the cam-interlocking groove 424C to press the right end toward the right wall 10C, thereby returning the slide stopper 424 to the initial position as shown in FIG. 5. By the above-described movement of the slide stopper 424 toward the right wall 10C, the cutout 424G1, the and the ejection-restricting window 424E are also moved toward the right wall 10C. By the movement of the second driving cam 45 toward the right wall 10C, the turntable 23 is also moved downward to stop clamping the small-diameter disc 1B, and the guide lever 411 and the ejection arm 432, whose movement restriction has been removed at the same time, holds the small-diameter disc 1B. Then, when the first driving cam 44 is moved toward the rear face 10D, the movement restriction of the load arm 421 is also removed. The guide lever 411, the ejection arm 432 and the load arm 421 subsequently transfer the small-diameter disc 1B toward the front face 10A and press the disc 1B for ejection through the slot 11.

### [Effect and Advantage of Disc Unit]

As described above, the disc unit 100 according to the above embodiment can be switched between the initial state, the guide-restricted state and the movement-unrestricted state by sliding the slide stopper 424 in the right and left directions. The first plate spring 413E and the second plate spring 413F biases the slide stopper 424 in the direction to be returned to the initial position in the guide-restricted state and the movement-unrestricted state. With this arrangement, the disc unit 100 can be easily switched between the guide-restricted state and the movement-unrestricted state by moving the slide stopper 424 either in the right or left direction. Since the slide stopper 424 is biased by the first plate spring 413E and the second plate spring 413F to be returned to the initial position, the slide stopper 424 can be constantly returned to the initial position unless the disc unit 100 is either in the guide-restricting state or the movement-unrestricted state. Thus, with a simplified arrangement, the disc unit 100 can be switched between the initial state, the guide-restricted state and the movement-unrestricted state. Particularly, when the disc unit 100 is a thinned slot-in type unit as in the above embodiment, an increase in the number of parts used therein or in the size of a mechanism for transferring the optical disc 1 makes the thinning of the unit difficult because of a need to secure a sufficient inner space within the disk unit. However, by employing such a simplified structure as described above, the thinning of the disc unit 100 can be realized.

The slide stopper 242 switches the state of the disc unit 100 between the initial state, the guide-restricted state and the movement-unrestricted state by engaging or disengaging with or from the arm-restricting pin 414A of the 8 cm arm 414 or by engaging or disengaging with or from the engaging projection 423C of the link arm 433. Thus, a complicated structure for switching the states of the disc unit is not necessary, thereby facilitating the structure.

Since the slide stopper 424 is flat-plate shaped, the thickness dimension of the disc unit can be reduced, thereby realizing the thinning of the disc unit.

The second plate spring 413F biases the arm-restricting pin 414A of the 8 cm arm 414, which is engaged with the cutout 424G1 or the restricting oblique portion 424G2 of the slide stopper 424 in the guide-restricted state, in a direction in which the arm-restricting pin 414A is disengaged therefrom. With this arrangement, the slide stopper 424 can be moved toward the right wall 10C concurrently with the downward movement of the turntable 23 when the optical disc 1 is ejected, such that the guide lever 411 and the ejection arm 432 can be moved to a position for holding the optical disc 1. In other words, with a simple arrangement where the second plate spring 413F presses the spring-locking projection 424F of the slide stopper 424, the guide lever 411 and the ejection arm 432 can be easily moved to hold the optical disc 1.

When the engaging projection 423C, which is engaged with the oblique abutment portion 424A for pressing the slide stopper 424 toward the right wall 10C in the movement-unrestricted state, is disengaged therefrom, the first plate spring 413E presses the slide stopper 424 toward the left wall 10B to return the slide stopper 424 to the initial position. Accordingly, when the large-diameter disc 1A is inserted, the slide stopper 424 can restrict the movement region of the arm-restricting pin 414A of the 8 cm arm by the restricting stopper 424B to within a region adjacent to the rear face 10D. In other words, with a simple arrangement where the first plate spring 413E presses the spring-locking projection 424F of the slide stopper 424 toward the left wall 10B, the movement region of the guide lever 411 connected to the ejection arm 414 can be easily restricted.

### MODIFICATIONS OF EMBODIMENT

It should be noted that the present invention is not limited to the exemplary embodiments described above, but may include modifications described below within a scope where an object of the present invention can be achieved.

For instance, although the slide stopper 424 in the guide restricting state and the movement-unrestricted state is biased by the plate springs 413E, 413F to return to the initial position according to the above embodiment, the slide stopper 424 may be biased to be moved to a position either of the guide-restricted state and the movement-unrestricted state.

Although the first plate spring 413E and the second plate spring 413F that extend from the rear side toward the front face 10A are provided in the above embodiment, the arrangement is not limited thereto. For instance, a singular plate spring may extend from the rear side toward the front face 10A with two spring-locking projections for sandwiching the plate spring from the right and left directions being formed on the slide stopper 424. In such an arrangement, when the slide stopper 424 is moved toward the left wall 10B, the right spring-locking projection abuts on the plate spring so as to be biased by the plate spring toward the right wall 10C. On the other hand, when the slide stopper 424 is moved toward the right wall 10C, the left spring-locking projection abuts on the plate spring so as to be biased by the plate spring toward the left wall 10B.

Although the cutout 424G1 and the restricting oblique portion 424G2, with which the arm-restricting pin 414A is engaged, are provided on the slide stopper 424 in the above embodiment, the arrangement is not limited thereto. For instance, the slide stopper 424 may be provided with an engaging pin to be engageable with an engaging groove provided in the 8 cm arm 414 at a predetermined position.

Although the biasing unit is exemplified by the first and second plate springs 413E, 413F in the above embodiment, for instance, coil springs respectively provided on the right and left ends of the slide stopper 424 in a protruding manner may be bowed by abutting respectively on the right wall 10C and the left wall 10B so as to bias the slide stopper 424.

Specific configurations when implementing the present invention may be altered as necessary to other configurations or the like as long as an object of the present invention can be attained.

### EFFECTS OF EMBODIMENT

As described above, the disc unit 100 according to the above embodiment can be switched between the initial state, the guide restricting state and the movement-unrestricted state by sliding the slide stopper 424 in the right and left directions. The slide stopper 424 in the guide restricting state and the movement-unrestricted state is biased by the first plate spring 413E and the second plate spring 413F in the direction to return to the initial position. With this arrangement, the disc device can be easily switched between the guide-restricted state and the movement-unrestricted state by moving the slide stopper 424 in either direction, and the slide stopper 424 can be constantly returned to the initial position by the first plate spring 413E and the second plate spring 413F unless in the guide-restricted state or the movement-unrestricted state. Thus, with a simplified arrangement, the disc unit 100 can be switched between the initial state, the guide-restricted state and the movement-unrestricted state.

### INDUSTRIAL APPLICABILITY

The present invention is applicable to a transfer device for inserting and ejecting a disc recording medium, and a recording-medium driver provided with the transfer device.

1. A transfer device, comprising:
a transfer unit comprising: a guide member that guides a disc recording medium into a driver body, the guide member being adapted to be advanced and retracted relative to a transfer path along which the recording medium is transferred; a stopper member that switches a guiding state in which the guide member guides the recording medium; and a load arm whose first end abuts on the recording medium while whose second end is rotatable, the load arm switching the guiding state of the guide member by the stopper member in accordance with a diameter of the recording medium; and
a biasing unit that biases the stopper member so that the guide member becomes a predetermined guiding state.

2. The transfer device according to claim 1, wherein
the stopper member is movable in accordance with a movement of the load arm, the guide member being moved in a manner corresponding to a diameter of the recording medium, the stopper member restricting the movement of the guide member in accordance with the diameter of the recording medium, and
the stopper member is biased by the biasing unit to restrict the guide member in a movement-unrestricted state to a position corresponding to the diameter of the recording medium.

3. The transfer device according to claim 1, wherein
the stopper member is adapted to move a cam member in interlock with the stopper member, the cam member being operated so that the recording medium is held by a turntable adapted to rotatably hold the recording medium, the stopper member moving the guide member to be closer to or away from the recording medium in accordance with the movement of the cam member, and
the biasing unit biases the stopper member so that the guide member approaches the recording medium.

4. The transfer device according to claim 1, wherein the stopper member is engageable with and disengageable from the guide member, the stopper member switching the guiding state of the guide member in accordance with whether or not the stopper member is in engagement with the guide member.

5. The transfer device according to claim 1, wherein
the guide member comprises a pin member,
the stopper member comprises an engaging groove engageable with and disengageable from the pin member, and
the biasing unit biases the stopper member so that the pin member is either engaged with or disengaged from the engaging groove.

6. The transfer device according to claim 3, wherein
the guide member comprises a pin member,
the stopper member comprises an oblique portion that abuts on the pin member to move the guide member in a predetermined direction, and
the biasing unit biases the stopper member so that the pin member is either engaged with or disengaged from the oblique portion.

7. The transfer device according to claim 4, wherein
the guide member comprises a pin member,
the stopper member comprises an oblique portion that abuts on the pin member to move the guide member in a predetermined direction, and
the biasing unit biases the stopper member so that the pin member is either engaged with or disengaged from the oblique portion.

8. A recording medium driver, comprising:
the transfer device according to claim 1;
a processor adapted to perform processing on the recording medium; and
the driver body that houses the transfer device and the processor therein and comprises an opening from which the recording medium is inserted or ejected.
